(19) United States
(12) Patent Application Publication
(10) Pub. No.: US 2026/0322440 A1
(43) Pub. Date: Oct. 15, 2026

(54) ANTENNA BEAM SELECTION AND MANAGEMENT SYSTEMS

(71) Applicant: GM GLOBAL TECHNOLOGY OPERATIONS LLC, Detroit, MI (US)

(72) Inventors: Sheng LIU, Novi, MI (US); Chuan LI, Troy, MI (US); Fan BAI, Ann Arbor, MI (US)

(21) Appl. No.: 19/176,393

(22) Filed: Apr. 11, 2025

(51) Int. Cl. H04B 7/06; H04W 28/02

(52) U.S. Cl. CPC H04B 7/0617; H04B 7/0632; H04B 7/0634; H04W 28/0289

(57) ABSTRACT

A system for a base station to manage antenna beam selections, includes an antenna configured to generate beams and a control module in communication with the antenna. The control module is configured to acquire, from at least one first sensor of a first vehicle, location data representing a location of the first vehicle traveling along a roadway, acquire, from a plurality of second sensors of the first vehicle, exterior sensor data representing a location of at least one second vehicle traveling along the roadway and in close proximity to the first vehicle, determine a beam of the beams allocated for the first vehicle based on the location data and the exterior sensor data from the first vehicle, and generate a control signal for the antenna to generate the beam for cellular communication capable devices in the first vehicle. Other example systems and methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to antenna beam selection and management systems.

User equipment or devices capable of cellular connection, such as cell phones, vehicle components, etc. connect with base stations via antennas for enabling wireless communication. For example, if user equipment is in a moving vehicle, the user equipment may connect to multiple base stations to allow the user equipment to connect to a cellular network as the vehicle moves. In such examples, an antenna beam selection process is implemented to connect the user equipment to particular ones of base stations, in which a direction to focus an antenna's beam is selected and adjusted to steer the beam towards the user equipment. This beam selection and adjustment is achieved through channel state information (CSI) and signal strength-based beam tracking, relying on CSI and precoding matrix indicator (PMI) feedback from the user equipment.

### SUMMARY

A system for a base station to manage antenna beam selections, includes an antenna configured to generate a plurality of beams and a control module in communication with the antenna. The control module is configured to acquire, from at least one first sensor of a first vehicle, location data representing a location of the first vehicle traveling along a roadway, acquire, from a plurality of second sensors of the first vehicle, exterior sensor data representing a location of at least one second vehicle traveling along the roadway and in close proximity to the first vehicle, determine a beam of the plurality of beams allocated for the first vehicle based on the location data and the exterior sensor data from the first vehicle, and generate a control signal for the antenna to generate the beam for cellular communication capable devices in the first vehicle.

In other features, the at least one first sensor of the first vehicle includes at least one of a global positioning system (GPS) sensor, a camera, a lidar sensor, or a radar sensor, and the plurality of second sensors of the first vehicle includes at least one of a camera, a lidar sensor, or a radar sensor.

In other features, the beam allocated for the first vehicle is a first beam, and the control module is configured to determine a second beam of the plurality of beams different than the first beam and allocated for the second vehicle, and generate a control signal for the antenna to generate the second beam for cellular communication capable devices in the second vehicle.

In other features, the beam allocated for the first vehicle is a first beam, and the control module is configured to receive a precoding matrix indicator (PMI) and a channel quality indicator (CQI) from the cellular communication capable devices in the first vehicle, determine a second beam of the plurality of beams based on the PMI and the CQI, and in response to the first beam being different than the second beam, select the first beam for the first vehicle.

In other features, the control module is configured to receive a subsequent CQI from at least one of the cellular communication capable devices based on the selected first beam, and in response to the subsequent CQI being less than a defined threshold, select the second beam for the first vehicle.

In other features, the control module is configured to determine a short-term beam prediction for the first vehicle and a long-term beam prediction for the first vehicle, and select a predicted beam from the plurality of beams for the first vehicle based on the short-term beam prediction and the long-term beam prediction.

In other features, the control module is configured to determine the short-term beam prediction with a Kalman filter and determine the long-term beam prediction with a neural network.

In other features, the control module is configured to determine a congestion level for the predicted beam and reserve the predicted beam for the first vehicle in response to the congestion level being less than a threshold.

In other features, the control module is configured to receive a notification from the first vehicle indicating a priority application and reserve a predetermined beam from the plurality of beams for the first vehicle in response to the notification.

In other features, the predetermined beam is a first beam, and the control module is configured to determine if the first beam overlaps with a second beam of the plurality of beam, reassign the second beam to another vehicle, and position the second beam remote from the first beam to minimize interference.

In other features, the control module is configured to determine whether the beam allocated for the first vehicle overlaps with a congested area of beams, and relocate the beam to a non-congested area of beams.

In other features, the control module is configured to implement a greedy algorithm to relocate the beam to the non-congested area of beams a minimal distance away from an original location of the beam.

In other features, the control module is configured to acquire, from at least one first sensor of the second vehicle, location data representing a location of the second vehicle traveling along the roadway, acquire, from a plurality of second sensors of the second vehicle, exterior sensor data representing a location of other vehicles traveling along the roadway, and select the beam allocated for the first vehicle based on the location data and the exterior sensor data from the second vehicle.

In other features, the beam allocated for the first vehicle is one of an unoccupied beam or a shelter beam allocated for the second vehicle traveling in front of the first vehicle.

In other features, the control module is configured to implement a rules-based algorithm to determine the beam allocated for the first vehicle.

In other features, the control module is configured to implement a machine learning algorithm to determine the beam allocated for the first vehicle.

A method for managing antenna beam selections at a base station having an antenna configured to generate a plurality of beams, includes acquiring, from at least one first sensor of a first vehicle, location data representing a location of the first vehicle traveling along a roadway, acquiring, from a plurality of second sensors of the first vehicle, exterior sensor data representing a location of at least one second vehicle traveling along the roadway and in close proximity to the first vehicle, determining a beam of the plurality of beams allocated for the first vehicle based on the location data and the exterior sensor data from the first vehicle, and generating a control signal for the antenna to generate the beam for cellular communication capable devices in the first vehicle.

In other features, the beam allocated for the first vehicle is a first beam, the method further includes receiving a precoding matrix indicator (PMI) and a channel quality indicator (CQI) from at least one of the cellular communication capable devices in the first vehicle, and determining a second beam of the plurality of beams based on the PMI and the CQI, and determining the beam allocated for the first vehicle includes selecting the first beam for the first vehicle in response to the first beam being different than the second beam.

In other features, the method further receiving a subsequent CQI from at least one of the cellular communication capable devices based on the selected first beam, and determining the beam allocated for the first vehicle includes selecting the second beam for the first vehicle in response to the subsequent CQI being less than a defined threshold.

A system for a base station to manage antenna beam selections, includes a first vehicle including a plurality of sensors and one or more cellular communication capable devices, an antenna configured to generate a plurality of beams, and a control module in communication with the antenna. The control module is configured to acquire, from a first sensor of the plurality of sensors in the first vehicle, location data representing a location of the first vehicle traveling along a roadway, acquire, from a second sensor of the first vehicle, exterior sensor data representing a location of at least one second vehicle traveling along the roadway and in close proximity to the first vehicle, determine a first beam of the plurality of beams allocated for the first vehicle based on the location data and the exterior sensor data from the first vehicle, receive a precoding matrix indicator (PMI) and a channel quality indicator (CQI) from at least one of the cellular communication capable devices in the first vehicle, determine a second beam of the plurality of beams based on the PMI and the CQI, in response to the first beam being different than the second beam, select the first beam for the first vehicle, receive a subsequent CQI from at least one of the cellular communication capable devices based on the selected first beam, and in response to the subsequent CQI being less than a defined threshold, select the second beam for the first vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example system for managing beam selections and allocations in a base station, according to the present disclosure;

FIG. 2 is a vehicle including sensors for communicating with the base station of FIG. 1, according to the present disclosure;

FIG. 3 is a block diagram of vehicles traveling along a roadway, where at least one vehicle provides location data for that vehicle and other vehicles near the vehicle, according to the present disclosure;

FIG. 4 shows graphs representing a position-based beam allocation and a conventional CSI and signal strength-based allocation for vehicles traveling along a roadway, according to the present disclosure;

FIG. 5 is a block diagram of an example system for implementing a handshake procedure between a control module in the base station of FIG. 1 and vehicles, according to the present disclosure;

FIG. 6 is a flow chart of an example control process for implementing a handshake procedure between a control module in the base station of FIG. 1 and vehicles, according to the present disclosure;

FIG. 7 shows a graph representing beam dynamics for a handover pre-fetch beam allocation strategy, according to the present disclosure;

FIG. 8 is a flow chart of an example control process for evaluating predicted beams for a vehicle based on congestion levels, according to the present disclosure;

FIG. 9 shows graphs representing beam dynamics for a priority-aware beam reassignment strategy, according to the present disclosure;

FIG. 10 shows graphs representing beam dynamics for a congestion-aware beam reassignment strategy, according to the present disclosure;

FIG. 11 shows graphs representing beam dynamics for a congestion-aware beam reassignment strategy based on vehicle collaborations, according to the present disclosure; and

FIG. 12 is a flow chart of an example control process for a congestion-aware beam reassignment strategy based on collaborations using a rules-based algorithm.

In the drawings, reference numbers may be reused to identify similar and/or identical elements.

### DETAILED DESCRIPTION

User equipment or devices capable of cellular connection, such as cell phones, vehicle components, etc. connect with base stations via antennas for enabling wireless communication. For example, if user equipment is in a moving vehicle, the user equipment may connect to multiple base stations to allow the user equipment to connect to a cellular network as the vehicle moves. Conventionally, an antenna beam selection process for connecting the user equipment to particular ones of base stations utilized channel state information (CSI) and signal strength-based beam tracking to select and adjust antenna beams, relying on CSI and precoding matrix indicator (PMI) feedback from the user equipment.

In many cases, beam over-connection occurs, in which multiple devices connect to the same or adjacent beams while other nearby beams remain underutilized. This often occurs during, for example, high device density scenarios. Beam over-connection is detrimental, causing increased interference/noise, lower data rates, beam contention, capacity overload, complex beam management, and beam usage imbalance. While CSI and signal strength-based beam tracking may alleviate some of these issues, this conventional antenna beam selection process increases interference/noise and often causes a ping-pong beam switching in which devices bounce between different beams.

The systems and methods according to the present disclosure leverage acquired global positioning system (GPS) data of a vehicle and advanced driver-assistance system (ADAS) data to acquire accurate relative positions of other vehicles, and apply beam allocation for the vehicle and/or a device in the vehicle based on the acquired vehicle GPS data and ADAS data, thereby enhancing beam tracking accuracy. For example, and as further explained below, the systems and methods herein utilize the GPS position from the vehicle and ADAS-based estimations of nearby foreign GPS positions to optimize beam allocation within a cluster. By spreading the serving beam intelligently, the systems and methods reduce excessive interference. Additionally, to implement this position-based beam tracking system, the systems and methods can utilize a customized handshake procedure between a base station (BS) and the vehicle and/or the device, and one or more different beam assignment strategies to efficiently assign optimized beams to different vehicles. This enables the systems and methods to prioritize high-criticality scenarios and enhance fairness, while also minimizing resource waste, mitigating excessive interference, preventing ping-pong oscillations, and reducing beam-switching delays.

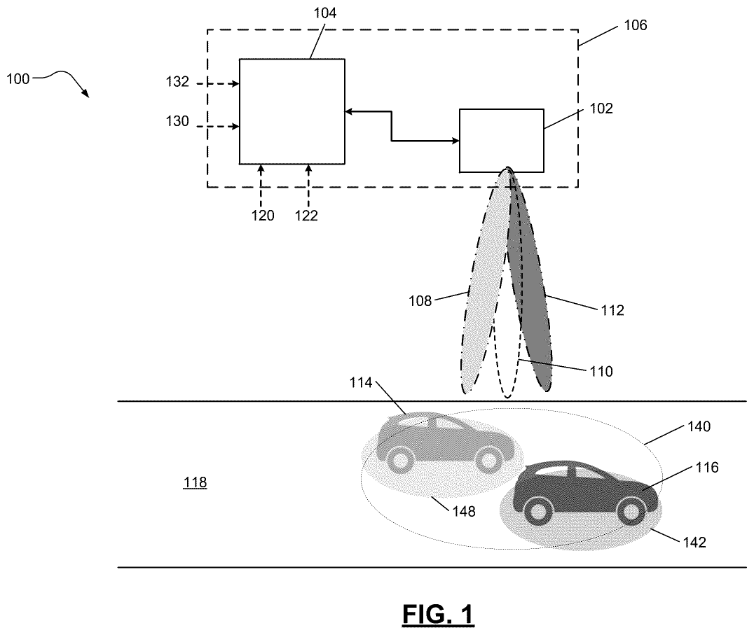

Referring now to FIG. 1, a block diagram of an example system 100 is presented for managing antenna beam selections and allocations in a BS. As shown in FIG. 1, the system 100 generally includes at least one antenna 102 and a control module 104 in communication with the antenna 102. In the example of FIG. 1, the antenna 102 and the control module 104 may be a portion of a BS 106 which may include additional components. For example, the BS 106 may include a switching device, a transceiver module for generating wirelessly signals for transmission and receiving wirelessly signals via the antenna 102, etc. In some examples, the additional components may be part of the control module 104 or external to but in communication with the control module 104.

While the system 100 of FIG. 1 is shown as including one BS 106, it should be appreciated that the system 100 may include multiple base stations. In such examples, each BS may include components and functionality (as further explained below) similar to the BS 106.

As shown in FIG. 1, the antenna 102 may generate multiple beams, such as beams 108, 110, 112. In this example, the beam 108 is represented by an oval having a dash-dot-dash configuration, the beam 110 is represented by an oval having a dashed configuration, and the beam 112 is represented by an oval having a dash-dot-dot-dash configuration. As shown, the beams 108, 110, 112 are generally directed towards vehicles 114, 116 traveling along a roadway 118. While the system 100 of FIG. 1 is shown as including only two vehicles, it should be appreciated more or less vehicles may be present.

In the example of FIG. 1, one or both vehicles 114, 116 include multiples sensors. As one example, the vehicle 114 may include one or more sensors for determining a location of the vehicle 114 (e.g., a GPS sensor, etc.) and one or more ADAS sensors for capturing data (e.g., a location, etc.) of other vehicles traveling along the roadway 118 and in close proximity (e.g., adjacent) to the vehicle 114, such as the vehicle 116. In such examples, the sensors for determining a location of the vehicle 114 may include one or more GPS sensors, cameras, lidar sensors, radar sensors, etc. In some examples, the location of the vehicle 114 may be determined with a GPS sensor. In other examples, the location of the vehicle 114 may be determined with localization algorithms that take into account both location sensor data (from a GPS sensor) and data from cameras, lidar sensors, radar sensors, etc. Additionally, the ADAS sensors may include one or more cameras, lidar sensors, radar sensors, etc. The vehicle 116 may or may not include similar sensors.

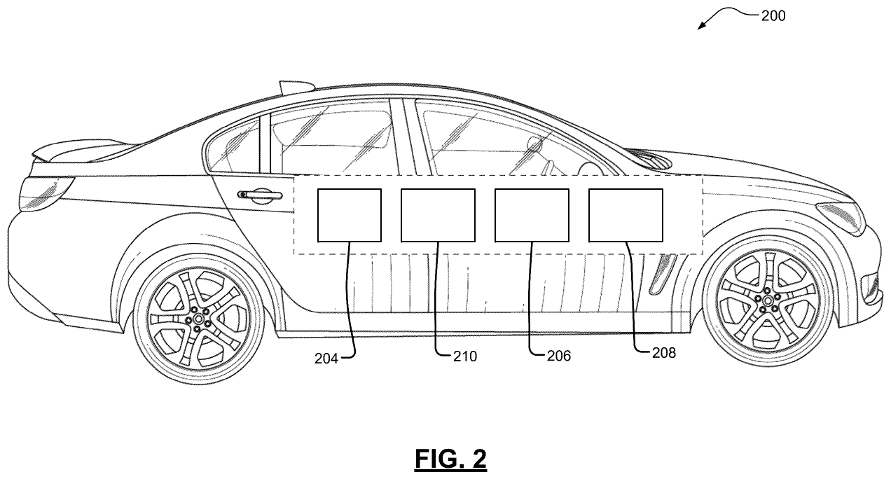

In various embodiments, the vehicles 114, 116 may be any suitable vehicle, such as electric vehicles (e.g., pure electric vehicles, plug-in hybrid electric vehicles, etc.), internal combustion engine vehicles, etc. Additionally, the vehicles 114, 116 can be autonomous vehicles, semi-autonomous vehicles, etc. For example, FIG. 2 depicts a vehicle 200 including a vehicle control module 204, a location sensor 206, ADAS sensors 208, and one or more cellular communication capable devices 210 as explained above. With this arraignment, a transceiver module (not shown) in or external to the vehicle control module 204 may communicate with the control module 104 by providing data obtained or derived by the location sensor 206 and the ADAS sensors 208. In such examples, the vehicle 200 may correspond to the vehicle 114 and/or the vehicle 116 of FIG. 1.

Referring back to FIG. 1, the BS 106 implements beam selection and allocation based on location. For example, in FIG. 1, the control module 104 acquires or otherwise receives sensor data from at least one of the vehicles 114, 116 and sometimes both vehicles 114, 116. While the examples described below generally focus on acquiring data from the vehicle 114 (e.g., an ego vehicle), it should be appreciated that similar data may be acquired from the vehicle 116. For instance, the control module 104 receives location data representing a location of the vehicle 114 traveling along the roadway 118. This location data may be provided by and/or based on the sensor(s) in the vehicle 114 (e.g., a location sensor housed in the vehicle 114, a location sensor of a mobile device positioned in the vehicle 114, etc.). As such, the location data may be provided by the vehicle 114 itself and/or a mobile device or another cellular communication capable device in the vehicle 114. Regardless of the source, the control module 104 may acquire the position data for the vehicle 114 via one or more signals 120. Similar position data for the vehicle 116 may be acquired by the control module 104 via one or more signals 130.

Additionally, the control module 104 acquires exterior sensor data representing a location of one or more other vehicles (e.g., the vehicle 116) traveling along the roadway 118 and in close proximity to the vehicle 114. This exterior data may be provided by ADAS sensors of the vehicle 114, as explained above. As such, the control module 104 receives the exterior data (e.g., location data) for the vehicle 116 via one or more signals 122. Similar exterior data for one or more other vehicles (e.g., the vehicle 114) may be acquired by the control module 104 via one or more signals 132.

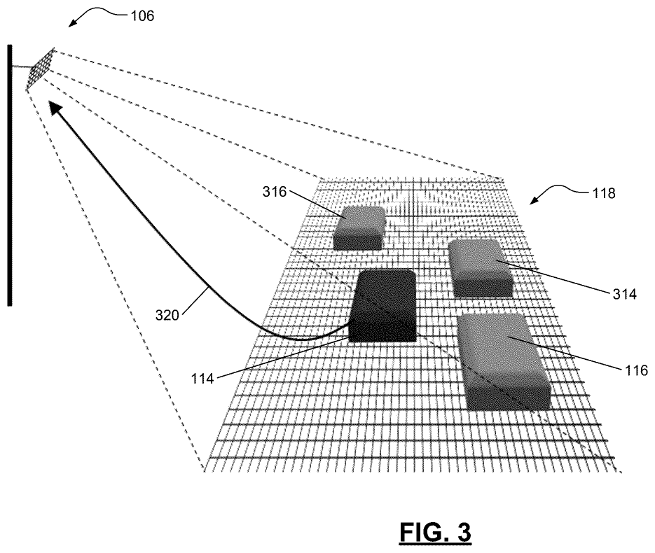

For example, FIG. 3 depicts one implementation fo such data acquisition from the vehicle 114 of FIG. 1 traveling along the roadway 118. As shown, the BS 106 acquires position (or location) data for the vehicle 114 itself, as well as position (or location) data for other vehicles near the vehicle 114, such as the vehicle 116 of FIG. 1 and vehicles 314, 316. In such examples, the BS 106 acquires the position data for the vehicle 114 and the position data for the other vehicles via one or more signals 320.

Referring back to FIG. 1, the control module 104 then determines a particular beam allocated for the vehicle 114 based on the location data and the exterior sensor data from the vehicle 114. Then, once a beam is determined, the control module 104 can generate a control signal for the antenna 102 to generate the beam for the vehicle 114 and/or a cellular communication capable device in the vehicle 114, such as a mobile device (e.g., a cell phone), a vehicle device, etc.

In such examples, the beam may be one of the multiple beams generatable by the antenna 102. The control module 104 may determine a particular beam for allocation in various suitable manners. As one example, the control module 104 may implement Equations (1)-(7) and table 1 below for determining the beam. For example, a global position of the vehicle 116 (or another vehicle) can be determined by the control module 104 according to Equations (1)-(3) and based on a location of the ego vehicle 114 (or another vehicle). In such examples, xᵢ, yᵢ, zᵢ represent coordinates for the vehicle 116 and xₐ, yₐ, zₐ represent coordinates for the vehicle 114 (e.g., as acquired from a location sensor in the vehicle 114). Additionally, rᵢ, θᵢ, φᵢ represent polar coordinates for the vehicle 116, which may be acquired from the ADAS sensor in the vehicle 114 as explained above. As such, rᵢ, θᵢ, φᵢ represent polar coordinates for the vehicle 116 relative to the vehicle 114 (or from the perceptive of the vehicle 114).

xᵢ=xₐ+rᵢ cos(θᵢ)cos(φᵢ) Equation (1)

yᵢ=yₐ+rᵢ sin(θᵢ)cos(φᵢ) Equation (2)

zᵢ=zₐ+rᵢ sin(φᵢ) Equation (3)

The control module 104 can determine an azimuth angle and an elevation angle for the vehicle 114 or vehicle 116 relative to the BS 106 according to Equations (4)-(5). In such examples, x_{BS}, y_{BS}, z_{BS} represent coordinates for the BS 106 and x, y, z represent current coordinates of the vehicle 114 or vehicle 116.

$${θ}_{AZ} = {tan}^{- 1} ( \frac{y - {y}_{BS}}{x - {x}_{BS}} ) \qquad Equation ( 4 )$$

$${θ}_{EL} = {tan}^{- 1} ( \frac{{z}_{BS} - z}{\sqrt{{( x - {x}_{BS} )}^{2} + {( y - {y}_{BS} )}^{2}}} ) \qquad Equation ( 5 )$$

Additionally, the control module 104 can implement Equations (6)-(7) below to map the azimuth angle and the elevation angle on a grid of possible beams. In this example, θ_{AZ} represents the azimuth angle at the center of the beam B_{k,m}, θ_{EL} represents the elevation angle at the center of the beam B_{k,m}, θ_{panel AZ} represents the azimuth angle at which the antenna panel is facing, θ_{panel EL} represents the elevation angle at which the antenna panel is tilted, BW_{H}(k,m) represents the angular range covered by the beam in the azimuth plane, and BW_{V}(k,m) represents the angular range covered by the beam in the elevation plane. Then, based on the azimuth angle (θ_{AZ}) and the elevation angle (θ_{EL}) for the vehicle 114, the control module 104 can assign one of the beams in Table 1 below for allocation to the vehicle 114.

$$Equation ( 6 )$$

$${θ}_{A Z} ∈ [ {θ}_{A {Z}_{k , m}} + {θ}_{p a n e {l}_{A Z}} - \frac{B {W}_{H} ( k , m )}{2} , {θ}_{A {Z}_{k , m}} + {θ}_{{panel}_{AZ}} + \frac{B {W}_{H} ( k , m )}{2} ]$$

$$Equation ( 7 )$$

$${θ}_{E L} ∈ [ {θ}_{E {L}_{k , m}} + {θ}_{p a n e {l}_{E L}} - \frac{B {W}_{V} ( k , m )}{2} , {θ}_{E {L}_{k , m}} + {θ}_{{panel}_{EL}} + \frac{B {W}_{V} ( k , m )}{2} ]$$

For example, if the azimuth angle (θ_{AZ}) is 17 degrees and the elevation angle (θ_{EL}) is 6 degrees, the control module 104 determines that the beam (4, 2) corresponding to a beam covered by θ_{AZ} ∈[15, 20) and θ_{EZ} ∈[5, 10). As another example, if the azimuth angle (θ_{AZ}) is 12 degrees and the elevation angle (θ_{EL}) is 13 degrees, the control module 104 determines that the beam (3, 3) corresponding to a beam covered by θ_{AZ} ∈[10, 15) and θ_{EZ} ∈[10, 15). While Table 1 provides example azimuth angles up to 25 degrees and elevation angles up to 15 degrees, it should be appreciated that in some examples, the azimuth angles and the elevation angles may range up to 180 degrees.

TABLE 1

| | Horizontal Beams (k) | | | | |
|---|---|---|---|---|---|
| Vertical | θ_{AZ} ∈[0, 5) | θ_{AZ} ∈[5, 10) | θ_{AZ} ∈[10, 15) | θ_{AZ} ∈[15, 20) | θ_{AZ} ∈[20, 25) |
| Beams | θ_{EZ} ∈[0, 5) | θ_{EZ} ∈[0, 5) | θ_{EZ} ∈[0, 5) | θ_{EZ} ∈[0, 5) | θ_{EZ} ∈[0, 5) |
| (m) | θ_{AZ} ∈[0, 5) | θ_{AZ} ∈[5, 10) | θ_{AZ} ∈[10, 15) | θ_{AZ} ∈[15, 20) | θ_{AZ} ∈[20, 25) |
| | θ_{EZ} ∈[5, 10) | θ_{EZ} ∈[5, 10) | θ_{EZ} ∈[5, 10) | θ_{EZ} ∈[5, 10) | θ_{EZ} ∈[5, 10) |
| | θ_{AZ} ∈[0, 5) | θ_{AZ} ∈[5, 10) | θ_{AZ} ∈[10, 15) | θ_{AZ} ∈[15, 20) | θ_{AZ} ∈[20, 25) |
| | θ_{EZ} ∈[10, 15) | θ_{EZ} ∈[10, 15) | θ_{EZ} ∈[10, 15) | θ_{EZ} ∈[10, 15) | θ_{EZ} ∈[10, 15) |

Additionally, the control module 104 may determine a particular beam allocated for the vehicle 116 if desired. In such examples, the beam allocated for the vehicle 116 may be different than the beam allocated for the vehicle 114. In such examples, the control module 104 may assign another beam for the vehicle 116 in any suitable manner, such as with a CSI and signal strength-based beam tracking system (as conventional) or with the position-based beam tracking system as described above. If the beam for the vehicle 116 is determined based on location data, the control module 104 may ascertain such data from the vehicle 114 (e.g., via ADAS sensors in the vehicle 114) and/or from the vehicle 116 itself (e.g., via a location sensor associated with the vehicle 116). After a beam is determined for the vehicle 116, the control module 104 can generate a control signal for the antenna 102 to generate the beam for the vehicle 114 and/or a cellular communication capable device in the vehicle 114, such as a mobile device (e.g., a cell phone), a vehicle device, etc.

With such beam allocation for particular vehicles 114, 116, the control module 104 is able to maintain adequate beam separation and balance beam usage. For example, and as shown in FIG. 1, the control module 104 may assign/allocate the beam 108 having coverage 148 for the vehicle 114 and the beam 112 having coverage 142 for the vehicle 116. With this arrangement, the BS 106 is able to utilize more spread-out beams than conventional systems, thereby reducing the frequency of beam switches which results in lower interference and better performance than conventional systems. For instance, a conventional system using CSI and signal strength for beam selection and allocation may assign/allocate the beam 110 having coverage 140 for both vehicles 114, 116, as shown in FIG. 1.

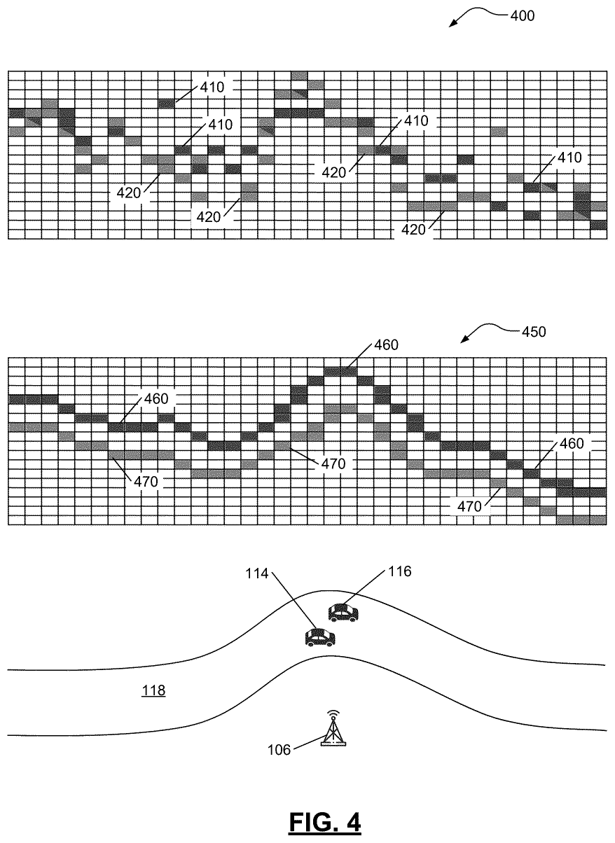

As one example, FIG. 4 depicts a position-based beam allocation and a conventional CSI and signal strength-based allocation for the vehicles 114, 116 traveling along the roadway 118 of FIG. 1. Specifically, in FIG. 4, a graph 400 represents beam dynamics for the conventional CSI and signal strength-based allocation, and a graph 450 represents beam dynamics for the position-based beam allocation herein.

As shown in the graph 400, beams occupied by the vehicle 116 are represented by darker boxes 410 and beams occupied by the vehicle 114 are represented by lighter boxes 420. The conventional approach struggles with high precision beam allocation, particularly when the vehicles 114, 116 are close together. This often results in the use of adjacent or shared beams (as shown in the graph 400), which in turn increases risk of interference between signals. Conversely, in the graph 450, beams occupied by the vehicle 116 are represented by darker boxes 460 and beams occupied by the vehicle 114 are represented by lighter boxes 470. With this position-based approach relying on accurate relative positioning of the vehicles 114, 116, beam management is significantly improved as compared to the conventional CSI and signal strength-based approach. Specifically, as shown in FIG. 4, the position-based approach is able to maintain separation between beams occupied by the different vehicles 114, 116. This reduces the risk of beam overlap and signal interference.

With continued reference to FIG. 1, a customized handshake procedure may be implemented between the BS 106 and any one of the vehicles 114, 116. More specifically, the BS 106 (e.g., the control module 104) and a device in any one of the vehicles 114, 116 (e.g., a mobile device, a vehicle device, etc.) may implement automated process of negotiating the exchange of information that establishes the protocols of a communication link at the start of the communication.

For example, FIG. 5 depicts an example system 500 for implementing a handshake procedure between the control module 104 and the vehicles 114, 116 (e.g., devices in the vehicles 114, 116) of FIG. 1. In the example of FIG. 5, the control module 104 manages beam selections and allocations in the BS 106 as explained herein. As shown, the control module 104 may receive or otherwise acquire a beam suggestion, a precoding matrix indicator (PMI) and a channel quality indicator (CQI) from device(s) in each vehicle 114, 116 via signals 520, 522, respectively. Additionally, the control module 104 generally transmits beams (or refined beams) 530, 532 to the device(s) in each vehicle 114, 116. Additionally, in FIG. 5, the vehicle 114 obtains polar coordinates (rᵢ, θᵢ, φᵢ) for the vehicle 116 via the ADAS sensors in the vehicle 114 as explained above. In FIG. 5, the polar coordinates are represented by signal 540. The control module 104 acquires, from the vehicle 114, location data for the vehicle 116 (e.g., coordinates xᵢ, yᵢ, zᵢ) for the vehicle 116 and location data for the vehicle 114 (coordinates xₐ, yₐ, zₐ), as explained above. This is shown by signal 550.

During operation of the handshake procedure, the control module 104 of FIG. 5 may broadcast synchronization signal block (SSB) beam to transmit control information to cellular communication capable devices in the vehicles 114, 116 and provide a location of the BS 106. Then, the control module 104 may receive a radio resource control (RRC) connection request from one or more cellular communication capable devices in the vehicle 114 (and/or the vehicle 116). Next, the control module 104 may receive a beam suggestion and location data from the device(s) in the vehicle 114 (and/or the vehicle 116). In such examples, the location data includes the polar coordinates (rᵢ, θᵢ, φᵢ) for the other surrounding vehicle (e.g., the vehicle 116) and the location data for the vehicle 114. Then, the control module 104 determines a beam based on the acquired location data, and transmits a refined beam towards the vehicle 114. The control module 104 then may receive a refined beam selection from the device(s) in the vehicle 114. With this approach, beam switch delay may be reduced as compared to conventional handshake procedures requiring PMI and CQI feedback.

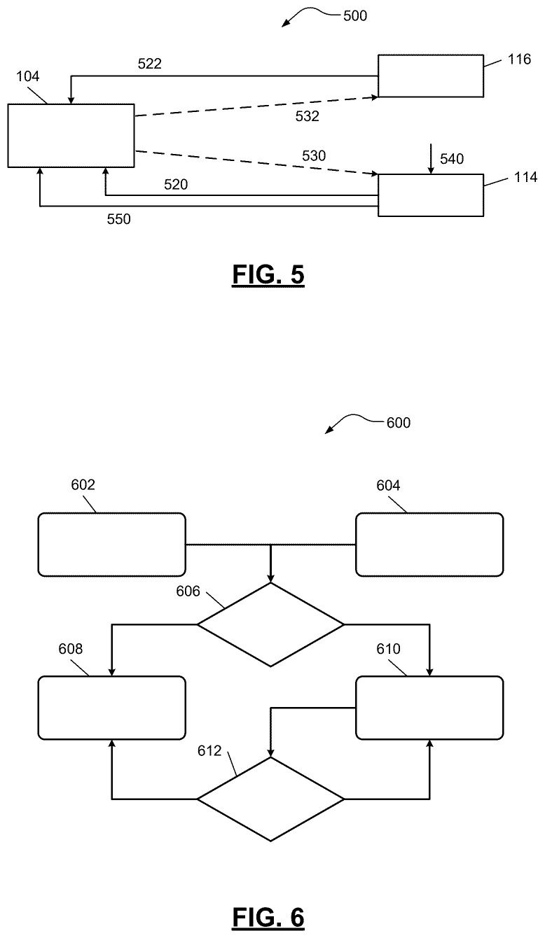

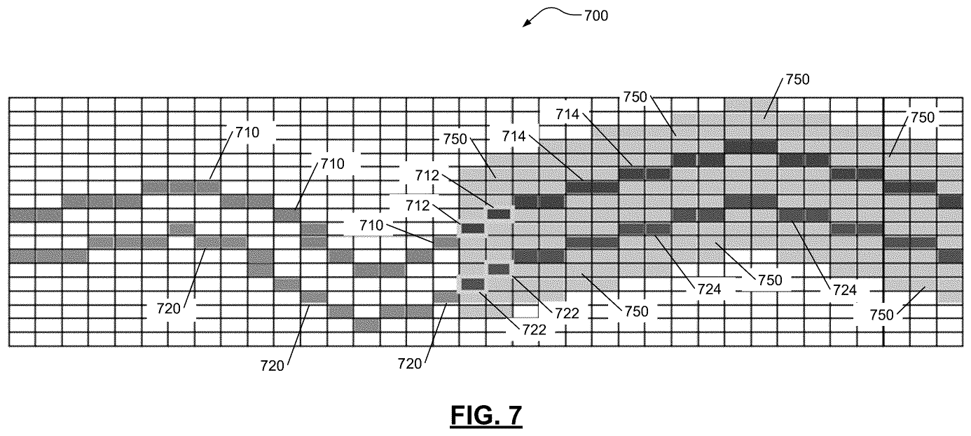

FIG. 6 depicts an example control process 600 for implementing a handshake procedure between the control module 104 and the vehicles 114, 116 (e.g., devices in the vehicles 114, 116) of FIG. 1, while also taking into account PMI and CQI feedback. As such, in this example, the control process 600 utilizes both CSI and position information as feedback from devices in the vehicles 114, 116, as compared to only CSI in conventional processes.

As shown in FIG. 6, the control module 104 determines two beam suggestions, one being a PMI-based beam suggestion (B1_{k,m}) at 602 and another being a position-based beam suggestion (B2_{k,m}) at 604. In such examples, the control module 104 may determine the PMI-based beam suggestion (B1_{k,m}) using conventional procedures based on CSI feedback. For example, the control module 104 may receive a PMI and a CQI from cellular communication capable device(s) in the vehicle 114 and determine a beam of the multiple beams generatable by the antenna 102 based on the PMI and the CQI. Additionally, the control module 104 may determine the position-based beam suggestion (B2_{k,m}) as explained above. In this example, k and m refer to horizontal beams and vertical beams, respectively, as referenced in Table 1 above.

Then, at 606, the control module 104 determines whether the PMI-based beam suggestion (B1_{k,m}) and the position-based beam suggestion (B2_{k,m}) are the same. If yes, the control process 600 proceeds to 608, where the control module 104 selects the PMI-based beam suggestion (B1_{k,m}) for transmission towards the vehicle 114. If no at 606 (e.g., the beam suggestions are different), the control process 600 proceeds to 610. At 610, the control module 104 selects the position-based beam suggestion (B2_{k,m}) for transmission towards the vehicle 114. Then, the control process 600 proceeds to 612.

At 612, the control module 104 determines whether CQI feedback received from the device(s) in the vehicle 114 is greater than or equal to a defined threshold. For example, the control module 104 may receive a subsequent CQI from device(s) in the vehicle 114 based on the selected position-based beam suggestion (B2_{k,m}). If yes, the control process 600 returns to 610 where the control module 104 maintains the selection of the position-based beam suggestion (B2_{k,m}) and may refine the position-based beam. However, if no at 612, the control process 600 proceeds to 608 where the control module 104 selects the PMI-based beam suggestion (B1_{k,m}) for transmission towards the vehicle 114. In other words, if the position-based beam suggestion (B2_{k,m}) is resulting in undesirable CQI, the control module 104 can change which beam is utilized for the vehicle 114 and refine the beam.

Referring back to FIG. 1, in various embodiments the BS 106 may implement a beam assignment strategy to efficiently assign optimized beams to different vehicles, such as the vehicles 114, 116. For example, the control module 104 may implement one of the four exemplary beam assignment strategies described below to efficiently assign optimized beams, aiming to reduce interference, minimize resource usage, and reduce beam switching delays. In such examples, the strategies may prioritize high-criticality scenarios, enhance fairness while minimizing resource waste, and prevent ping-pong oscillations.

For example, the control module 104 may implement a handover pre-fetch beam allocation strategy. With this beam allocation strategy, the control module 104 predicts a trajectory of a tracking beam to enable the BS 106 to preemptively prepare resource assignments for tracking and pre-allocate computing resources for beamforming. With this approach, the BS 106 can optimize resources, reduce a beam switch delay, and minimize computation overhead.

In such examples, the control module 104 may determine multiple predictions, such as a short-term beam prediction and a long-term beam prediction. For example, the control module 104 can determine a short-term beam prediction and a long-term beam prediction for the vehicle 114 (and/or the vehicle 116), and then select a predicted beam from the multiple beams generatable by the antenna 102 for the vehicle 114 (and/or the vehicle 116) based on the short-term beam prediction and the long-term beam prediction. In such examples, the control module 104 may determine the short-term beam prediction with a Kalman filter and determine the long-term beam prediction with a neural network (e.g., a 1D convolutional neural network (CNN), etc.).

For example, with the Kalman filter, the control module 104 may utilize a state vector according to [x, y, vx, vy]^{T}, where (x, y) are the current beam grid coordinates and (vx, vy) are the velocity components at a discrete time T. Then, the control module 104 may implement a state transition model (Fₖ) according to Equation (8) below to predict the next state based on the current state. In this example, Δt is the time increment. In some examples, the control module 104 may utilize a measurement model (Hₖ) according to Equation (9) below, which maps the true state space into the measured space (if measuring the grid coordinates directly).

$${F}_{k} = [ \begin{matrix}1 & 0 & Δ t & 0 \\ 0 & 1 & 0 & Δ t \\ 0 & 0 & 1 & 0 \\ 0 & 0 & 0 & 1\end{matrix} ] \qquad Equation ( 8 )$$

$${H}_{k} = [ \begin{matrix}1 & 0 & 0 & 0 \\ 0 & 1 & 0 & 0\end{matrix} ] \qquad Equation ( 9 )$$

Then, the control module 104 may implement Equations (10)-(14) below for making the short-term beam predictions. For example, Equations (10)-(11) may be used to determine the short-term beam predictions and Equations (12)-(14) may be used to update the Kalman filter. In such examples, Qₖ represents process noise and Rₖ represents measurement noise.

$${\hat{x}}_{k \vert k - 1} = {F}_{k} {\hat{x}}_{k - 1 \vert k - 1} \qquad Equation ( 10 )$$

$${P}_{k \vert k - 1} = {F}_{k} {P}_{k - 1 \vert k - 1} {F}_{k}^{T} + {Q}_{k} \qquad Equation ( 11 )$$

$${K}_{k} = {P}_{k \vert k - 1} {{H}_{k}^{T} ( {H}_{k} {P}_{k \vert k - 1} {H}_{k}^{T} + {R}_{k} )}^{- 1} \qquad Equation ( 12 )$$

$${\hat{x}}_{k \vert k} = {\hat{x}}_{k \vert k - 1} + {K}_{k} ( {z}_{k} - {H}_{k} {\hat{x}}_{k \vert k - 1} ) \qquad Equation ( 13 )$$

$${P}_{k \vert k} = ( I - {K}_{k} {H}_{k} ) {P}_{k \vert k - 1} \qquad Equation ( 14 )$$

With the neural network, the control module 104 may implement a simplified 1D CNN. With this approach, an input layer for the 1D CNN takes in the sequence of beam positions. Convolution layers for the 1D CNN may be represented by Equation (15) below, where all is the activation from layer l, W^{[l]} is the weight of the layer l, and b^{[l]} is the bias of the layer l. In Equation (15), g is a nonlinear activation function (e.g., ReLU).

$${a}^{[ l ]} = g ( {W}^{[ l ]} * {a}^{[ l - 1 ]} + {b}^{[ l ]} ) \qquad Equation ( 15 )$$

FIG. 7 depicts a graph 700 represents beam dynamics for the handover pre-fetch beam allocation strategy. As shown in FIG. 7, beams previously occupied by the vehicle 114 are represented by boxes 710 and beams previously occupied by the vehicle 116 are represented by boxes 720, as the vehicles 114, 116 are moving along the roadway 118 of FIG. 1. Short-term beam predictions that may be occupied by the vehicle 114 are represented by boxes 712 and short-term beam predictions that may be occupied by the vehicle 116 are represented by boxes 722. Long-term beam predictions that may be occupied by the vehicle 114 are represented by boxes 714 and long-term beam predictions that may be occupied by the vehicle 116 are represented by boxes 724. A road region (e.g., the roadway 118) is represented by boxes 750. In such examples, if the short-term beam predictions and/or the long-term beam predictions for the vehicles 114, 116 are outside the designated road region, the predictions may be disregarded.

In various embodiments, the control module 104 may take into account congestion of predicted beams. In such examples, the control module 104 determine a congestion level of the predicted beams and then reserve the predicted beam for the vehicle 114 (or the vehicle 116) in response to the congestion level being less than a threshold. For instance, the control module 104 may characterize a congestion level as low when the predicted beam is operating significantly below its maximum capacity while maintaining good QoS, characterize a congestion level as max when the predicted beam has exceeded its maximum capacity (e.g., currently showing degraded QoS), and characterize a congestion level as high when the predicted beam is nearing its maximum capacity, with only a few available slots remaining.

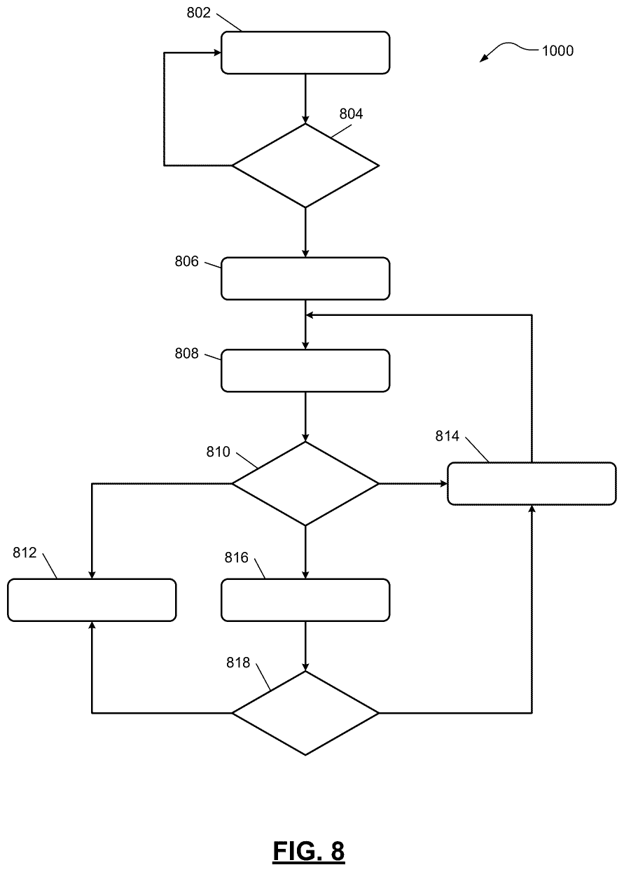

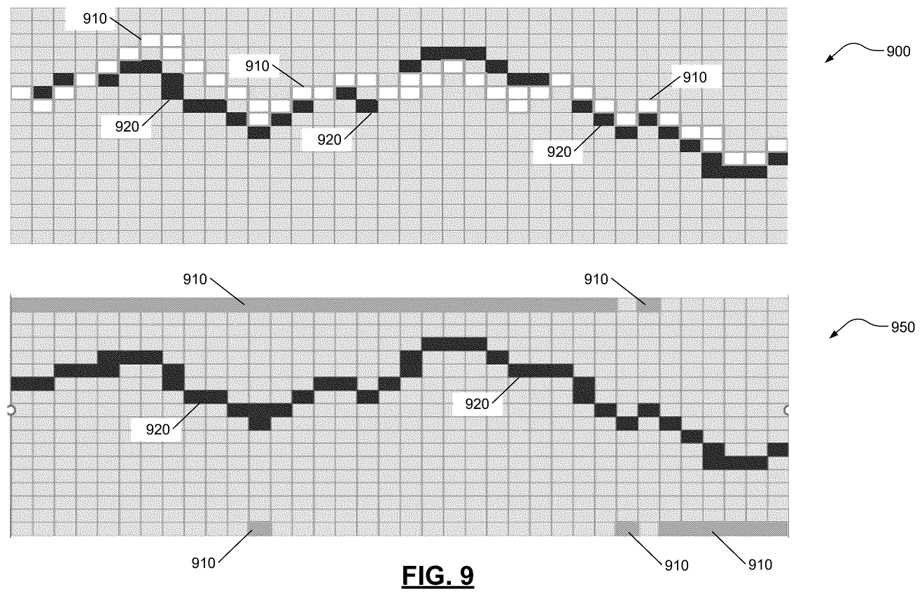

For example, FIG. 8 depicts an example control process 800 for evaluating predicted beams for the vehicle 114 based on congestion levels. As shown, the control process 800 begins at 802 by determining predicted beams for the vehicle 114 using, for example, a Kalman filter and a neural network as explained above. Then, at 804, the control module 104 implements a road in-change check to determine if the predicted beams are within a road region (e.g., the road region 750 of FIG. 7). If no, the control process 800 returns to 802. Otherwise, if yes at 804, the control process 800 proceeds to 806, 808.

At 806, the control module 104 selects a beam from the predicted beams (e.g., in a predicted beam index). Then, at 808, the control module 104 determines a congestion level (e.g., low level, high level, or maximum capacity) of that selected beam as explained above. The control process 800 then proceeds to 810, where the control module 104 takes different actions based on the congestion level.

For example, if the congestion level is low (L), the control module 104 reserves the selected (predicted) beam for the vehicle 114 at 812. If, however, the congestion level is maximum capacity (M), the control module 104 selects the next beam from the predicted beams at 814. The control process 800 then returns to 808. If the congestion level is high (H), the control module 104 implements a beam selection process at 816. For instance, the control module 104 may implement a first come, first serve beam selection process in which the first requesting device associated with a vehicle (e.g., the vehicle 114) takes precedence over later requests from of other devices. In other examples, the control module 104 may implement a priority-based selection process in which higher priority requests (e.g., from an emergency vehicle, etc.) take precedence over lower priority requests. In still other examples, the control module 104 may implement a random selection process.

After the beam selection process is completed at 816, the control process 800 proceeds to 818. At 818, the control module 104 determines whether to select the predicted beam for the vehicle 114. If no, the control process 800 returns to 814 where the control module 104 selects the next beam from the predicted beams. If yes, the control process 800 proceeds to 812 where the control module 104 reserves the selected (predicted) beam for the vehicle 114.

As another beam allocation strategy, the control module 104 may implement a priority-aware beam reassignment strategy. With this beam allocation strategy, the control module 104 may receive a notification from the vehicle 114 (or another vehicle) indicating a high priority application. In such examples, the vehicle 114 may be an emergency vehicle, such as a police vehicle, an ambulance, a fire truck, etc. having a high priority application (e.g., responding to an emergency call, etc.). Then, in response to the notification, the control module 104 can reserve a predetermined beam from the multiple beams generatable by the antenna 102 for the vehicle 114. For example, once the notification is received, the control module 104 can enlist a predetermined beam trace for the high priority application with a fixed route and then reserve corresponding beams and adjacent beams for the route that exclusive for the high-priority use.

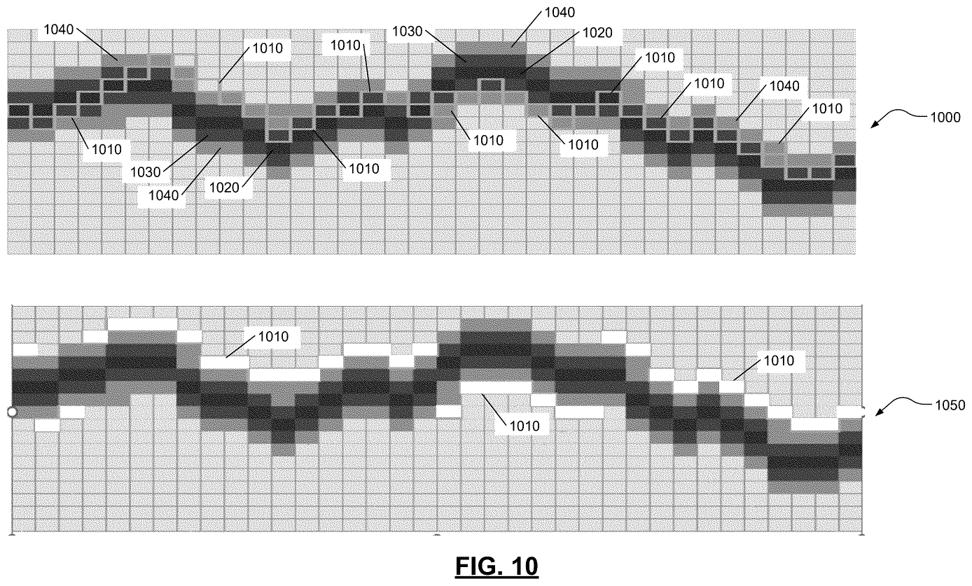

In some examples, beams reserved for the high priority application may overlap with other beams for lower priority applications. In such examples, the control module 104 may determine if the reversed beams overlap with the other beams, reassign the other beams to another vehicle having a low-priority application, and then position the reassigned beams remote from the reserved beams to minimize interference. For example, FIG. 9 depicts graphs 900, 950 representing beam dynamics illustrating such features.

For example, in FIG. 9, the graph 900 represents beam dynamics for the vehicles 114, 116 traveling along the roadway 118 of FIG. 1. Beams occupied by the vehicle 114 are represented by darker boxes 920 and beams occupied by the vehicle 116 are represented by lighter boxes 910. As shown, the beams for the vehicles 114, 116 overlap or are located adjacent to each, which may cause interference.

In this example, the vehicle 114 may be an emergency vehicle that provided a notification to the control module 104 indicating a high priority application. When this occurs, the control module 104 can reassign the beams occupied by the vehicle 116 (the lighter boxes 910) and then position the reassigned beams remote from the reserved beams to minimize interference. For example, in the graph 950, the beams (the darker boxes 920) occupied by the vehicle 114 remain in the same location and the beams (the lighter boxes 910) are now positioned as far away as possible in the vertical direction to minimize interference.

As another beam allocation strategy, the control module 104 may implement a congestion-aware beam reassignment strategy. With this beam allocation strategy, the control module 104 can address instances where the determined beam allocated for the vehicle 114 overlaps with or is located adjacent to congested areas of beams. In this example, the beam allocated for the vehicle 114 is determined according to the position-based beam allocation herein.

For example, the control module 104 may determine whether the beam allocated for the vehicle 114 overlaps with a congested area of beams, and then relocate the beam to a non-congested area of beams. In such examples, it may be desirable to minimize the distance from the original beam position to maintain intended coverage. As such, the control module 104 may implement a greedy algorithm to relocate the beam to the non-congested area of beams a minimal distance away from an original location of the beam. This relocation of the beam allocated for the vehicle 114 to a non-congested area of beams ensures efficient beam utilization and minimizes interference in high-traffic areas.

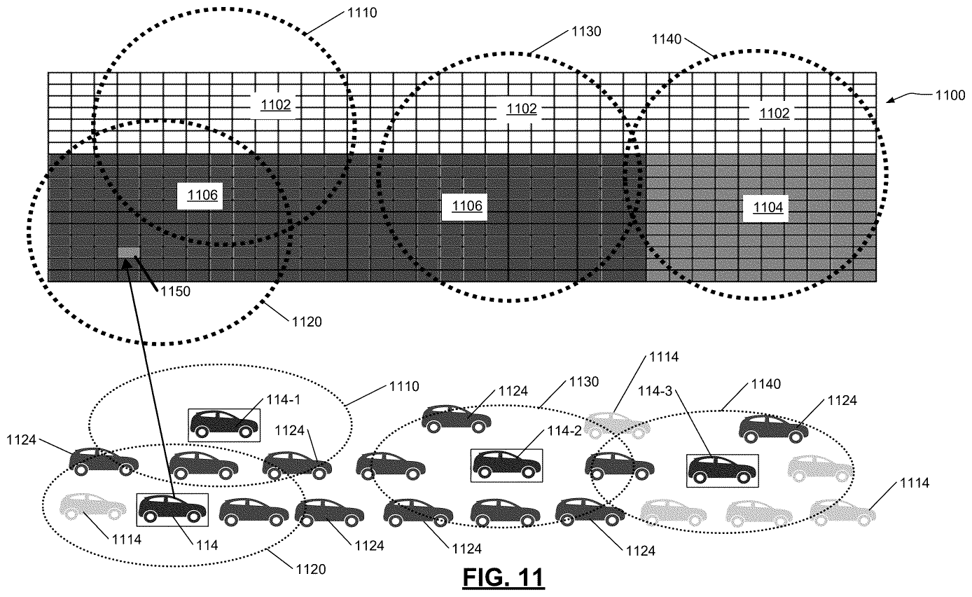

For instance, the control module 104 may characterize an area of beams as high congestion, median congestion, mild congestion or no congestion. In such examples, if the beam allocated for the vehicle 114 is in a no congestion area, the control module 104 does not relocate the beam. If, however, the beam allocated for the vehicle 114 is in a mild, median, or high congestion area, the control module 104 relocates the beam to a no congestion area. For example, FIG. 10 depicts graphs 1000, 1050 representing beam dynamics illustrating such features.

For example, in FIG. 10, the graph 1000 represents beam dynamics for the vehicle 114 traveling along the roadway 118 of FIG. 1. Beams occupied by the vehicle 114 are represented by outlined boxes 1010 and areas of beams having high congestion, median congestion, and mild congestion are shown by dark boxes 1020, medium dark boxes 1030, and light boxes 1040, respectively. As shown, the beams for the vehicle 114 overlap or are located adjacent to congested areas.

In this example, the control module 104 can relocate the beam (outlined boxes 1010) allocated for the vehicle 114 away from the congested areas and into a no congestion area. For example, in the graph 1050, the beam (white boxes 1010) allocated for the vehicle 114 are relocated to the outside of the congested areas, which equates to the minimal distance from the original beam position to maintain intended coverage.

As another beam allocation strategy, the control module 104 may implement a congestion-aware beam reassignment strategy based on collaborations from other vehicles. With this beam allocation strategy, the control module 104 can address instances where the determined beam allocated for the vehicle 114 overlaps with or is located adjacent to congested areas or regions of beams, and optimize beam assignments dynamically by maximizing collaborative efforts from vehicles willing to participate, ensuring efficient allocation for a portion of the traffic.

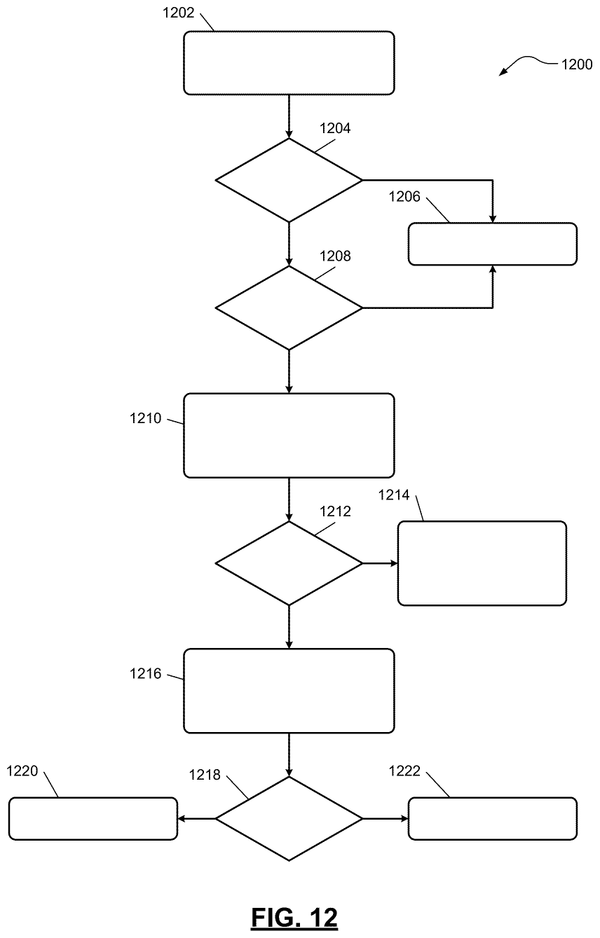

For example, FIG. 11 depicts an example of a congestion-aware beam reassignment strategy based on collaborations from other vehicles and the vehicle 114 of FIG. 1. In FIG. 11, a grid 1100 of beams includes a low congestion region 1102 (represented by white boxes), a low chaos region 1104 (represented by medium dark boxes), and a high congestion region 1106 (represented by dark boxes). The grid 1100 of beams also includes a shelter beam 1150 representing a known beam previously allocated for a vehicle traveling in front of the vehicle 114.

Beam coverage areas 1110, 1120, 1130, 1140 are shown on the grid 1100 and projected onto a roadway (e.g., the roadway 118 of FIG. 1) with various different vehicles as the vehicles move. For example, in FIG. 11, the vehicles include the vehicle 114 and vehicles 114-1, 114-2, 114-3 (e.g., collectively, ego vehicles) represented by vehicles with surrounding boxes, collaborating vehicles 1114, and non-collaborating vehicles 1214. In such examples, the collaborating vehicles 1114 are vehicles willing to provide their location data to, for example, the BS 106 (or the control module 104) of FIG. 1 for managing beam selections and allocations as explained herein. For example, the control module 104 may acquire location data from a sensor in each collaborating vehicle 1114 representing a location of that collaborating vehicle 1114 and exterior sensor data from ADAS sensors in each collaborating vehicle 1114 representing a location of other vehicles (e.g., other collaborating vehicle 1114 and non-collaborating vehicles 1214).

In this example, the BS 106 can assist the vehicles 114, 114-1, 114-2, 114-3 and the collaborating vehicles 1114 in the high congestion region 1106 to escape. For example, the control module 104 can select a beam for any one of these vehicles based on the location data and exterior sensor data from the vehicles 114, 114-1, 114-2, 114-3 and the collaborating vehicles 1114. With this approach, the control module 104 can select a beam for the vehicle to allow the vehicle to escape to a beam region of lower congestion, such as the low congestion region 1102 or the low chaos region 1104. In such examples, the selected beam may be an unoccupied beam (in the low congestion region 1102) or the shelter beam 1150. In various embodiments, the control module 104 may implement a rules-based algorithm or a machine learning algorithm to determine this selected beam, as further explained below.

For example, FIG. 12 depicts an example control process 1200 for congestion-aware beam reassignment strategy based on collaborations using a rules-based algorithm. With this rules-based algorithm approach, the BS 106 of FIG. 1 can be directed to reassign beam for vehicles in chaotic regions (e.g., in the high congestion region 1106) to beams in non-chaotic or low congestion areas (e.g., in the low chaos region 1104 or the low congestion region 1102), or to assign a shelter beam when available.

As shown in FIG. 12, the control process 1200 begins at 1202 where the control module 104 determines a congestion indicator (C) and a density of collaborating vehicles (H). In such examples, the congestion indicator (C) represents a value proportional to vehicle density determined by the control module 104 based on real-time traffic mapping data. Additionally, the density of collaborating vehicles (H) represents a value proportional to the density of the collaborating vehicles 1114 and the vehicles 114, 114-1, 114-2, 114-3 of FIG. 11, as determined by the control module 104 based on real-time traffic mapping data. The control process 1200 then proceeds to 1204.

At 1204, the control module 104 determines whether the congestion indicator (C) is greater than a congestion threshold. If no, the control process 1200 proceeds to 1206 where the control module 104 selects the nearest unoccupied beam. However, if yes at 1204, the control process 1200 proceeds to 1208. At 1208, the control module 104 determines whether the density of collaborating vehicles (H) is greater than a chaos threshold. If no, the control process 1200 proceeds to 1206 where the control module 104 selects the nearest unoccupied beam. However, if yes at 1208, the control process 1200 proceeds to 1210.

At 1210, the control module 104 determines a distance (D) of the nearest unoccupied beam in a region where the congestion indicator (C) is less than the congestion threshold (i.e., C<Congestion threshold). The control process 1200 then proceeds to 1212, where the control module 104 determines whether the distance (D) is less than a first distance threshold. In this example, the first distance threshold is a distance to a non-congestion region, where the first distance threshold is proportional to the congestion indicator (C). In other words, the more congestion (e.g., a higher congestion indicator (C)) results in a larger search distance allowed (e.g., a larger first distance threshold). If no at 1212, the control process 1200 proceeds to 1214 where the control module 104 selects the nearest unoccupied beam in the region where the congestion indicator (C) is less than the congestion threshold (i.e., C<Congestion threshold). However, if yes at 1212, the control process 1200 proceeds to 1216.

At 1216, the control module 104 determines a distance (Ds) of the nearest shelter beam (e.g., the shelter beam 1150 of FIG. 11), where a value(S) proportional to the CQI of the closest collaborating vehicle is greater than a shelter indicator threshold. Then, the control process 1200 proceeds to 1218, where the control module 104 determines whether the distance (Ds) is less than a second distance threshold. In this example, the second distance threshold is a distance value to the shelter beam and is generally a small value. If no at 1218, the control process 1200 proceeds to 1220 where the control module 104 selects a PMI-based beam as explained above. If yes at 1218, the control process 1200 proceeds to 1222 where the control module 104 selects the shelter beam.

In other examples, the control module 104 may implement a machine learning algorithm to determine this selected beam instead of the rules-based algorithm. In such examples, the control module 104 can use the machine learning algorithm to determine the closest beam that satisfies at least one of the conditions: (1) the congestion indicator (C) is less than a congestion threshold, (2) the density of collaborating vehicles (H) is greater than a chaos threshold, and (3) the value(S) proportional to the CQI of the closest collaborating vehicle is greater than a shelter indicator threshold. With this approach, it is desirable to minimize the absolute Manhattan distance between the current beam and the reassigned beam.

In various embodiments, the machine learning algorithm may implement reinforcement learning with rewards. With this approach, a state observer (e.g., an observation space) includes a dynamic map of beams, where each beam's properties (C, H, S) are updated periodically, and positions of the vehicles and their current beam assignments. Here, the machine learning algorithm may assign each vehicle currently connected to a bad beam (e.g., C≥the congestion threshold AND H≥the chaos threshold AND S≤the shelter indicator threshold) to one of the good beams (C≥the congestion threshold OR H≥the chaos threshold OR S≤the shelter indicator threshold).

In such examples, the machine learning algorithm may implement one or more rewards or penalties. For example, the machine learning algorithm may implement a reward if the Manhattan distance between the current beam and the new reassigned beam is less than a threshold. Additionally, the machine learning algorithm may implement one reward (e.g., +20) if C is greater than or equal to the congestion threshold or H is greater than or equal to the chaos threshold, and implement another reward (e.g., +10) if S is less than or equal to the shelter indicator threshold. Further, the machine learning algorithm may implement a penalty (e.g., −200 if no good beam is found or the current beam remains bad.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for a base station to manage antenna beam selections, the system comprising:
an antenna configured to generate a plurality of beams; and
a control module in communication with the antenna, the control module configured to:
acquire, from at least one first sensor of a first vehicle, location data representing a location of the first vehicle traveling along a roadway;
acquire, from a plurality of second sensors of the first vehicle, exterior sensor data representing a location of at least one second vehicle traveling along the roadway and in close proximity to the first vehicle;
determine a beam of the plurality of beams allocated for the first vehicle based on the location data and the exterior sensor data from the first vehicle; and
generate a control signal for the antenna to generate the beam for cellular communication capable devices in the first vehicle.

2. The system of claim 1, wherein:
the at least one first sensor of the first vehicle includes at least one of a global positioning system (GPS) sensor, a camera, a lidar sensor, or a radar sensor; and
the plurality of second sensors of the first vehicle includes at least one of a camera, a lidar sensor, or a radar sensor.

3. The system of claim 1, wherein:
the beam allocated for the first vehicle is a first beam; and
the control module is configured to determine a second beam of the plurality of beams different than the first beam and allocated for the second vehicle, and generate a control signal for the antenna to generate the second beam for cellular communication capable devices in the second vehicle.

4. The system of claim 1, wherein:
the beam allocated for the first vehicle is a first beam; and
the control module is configured to receive a precoding matrix indicator (PMI) and a channel quality indicator (CQI) from the cellular communication capable devices in the first vehicle, determine a second beam of the plurality of beams based on the PMI and the CQI, and in response to the first beam being different than the second beam, select the first beam for the first vehicle.

5. The system of claim 4, wherein the control module is configured to receive a subsequent CQI from at least one of the cellular communication capable devices based on the selected first beam, and in response to the subsequent CQI being less than a defined threshold, select the second beam for the first vehicle.

6. The system of claim 1, wherein the control module is configured to determine a short-term beam prediction for the first vehicle and a long-term beam prediction for the first vehicle, and select a predicted beam from the plurality of beams for the first vehicle based on the short-term beam prediction and the long-term beam prediction.

7. The system of claim 6, wherein the control module is configured to determine the short-term beam prediction with a Kalman filter and determine the long-term beam prediction with a neural network.

8. The system of claim 6, wherein the control module is configured to determine a congestion level for the predicted beam and reserve the predicted beam for the first vehicle in response to the congestion level being less than a threshold.

9. The system of claim 1, wherein the control module is configured to receive a notification from the first vehicle indicating a priority application and reserve a predetermined beam from the plurality of beams for the first vehicle in response to the notification.

10. The system of claim 9, wherein:
the predetermined beam is a first beam; and
the control module is configured to determine if the first beam overlaps with a second beam of the plurality of beam, reassign the second beam to another vehicle, and position the second beam remote from the first beam to minimize interference.

11. The system of claim 1, wherein the control module is configured to determine whether the beam allocated for the first vehicle overlaps with a congested area of beams, and relocate the beam to a non-congested area of beams.

12. The system of claim 11, wherein the control module is configured to implement a greedy algorithm to relocate the beam to the non-congested area of beams a minimal distance away from an original location of the beam.

13. The system of claim 1, wherein the control module is configured to:
acquire, from at least one first sensor of the second vehicle, location data representing a location of the second vehicle traveling along the roadway;
acquire, from a plurality of second sensors of the second vehicle, exterior sensor data representing a location of other vehicles traveling along the roadway; and
select the beam allocated for the first vehicle based on the location data and the exterior sensor data from the second vehicle.

14. The system of claim 13, wherein the beam allocated for the first vehicle is one of an unoccupied beam or a shelter beam allocated for the second vehicle traveling in front of the first vehicle.

15. The system of claim 13, wherein the control module is configured to implement a rules-based algorithm to determine the beam allocated for the first vehicle.

16. The system of claim 13, wherein the control module is configured to implement a machine learning algorithm to determine the beam allocated for the first vehicle.

17. A method for managing antenna beam selections at a base station having an antenna configured to generate a plurality of beams, the method comprising:
acquiring, from at least one first sensor of a first vehicle, location data representing a location of the first vehicle traveling along a roadway;
acquiring, from a plurality of second sensors of the first vehicle, exterior sensor data representing a location of at least one second vehicle traveling along the roadway and in close proximity to the first vehicle;
determining a beam of the plurality of beams allocated for the first vehicle based on the location data and the exterior sensor data from the first vehicle; and
generating a control signal for the antenna to generate the beam for cellular communication capable devices in the first vehicle.

18. The method of claim 17, wherein:
the beam allocated for the first vehicle is a first beam;
the method further includes receiving a precoding matrix indicator (PMI) and a channel quality indicator (CQI) from at least one of the cellular communication capable devices in the first vehicle, and determining a second beam of the plurality of beams based on the PMI and the CQI; and
determining the beam allocated for the first vehicle includes selecting the first beam for the first vehicle in response to the first beam being different than the second beam.

19. The method of claim 18, wherein:
the method further receiving a subsequent CQI from at least one of the cellular communication capable devices based on the selected first beam; and
determining the beam allocated for the first vehicle includes selecting the second beam for the first vehicle in response to the subsequent CQI being less than a defined threshold.

20. A system for a base station to manage antenna beam selections, the system comprising:
a first vehicle including a plurality of sensors and one or more cellular communication capable devices;
an antenna configured to generate a plurality of beams; and
a control module in communication with the antenna, the control module configured to:
acquire, from a first sensor of the plurality of sensors in the first vehicle, location data representing a location of the first vehicle traveling along a roadway;
acquire, from a second sensor of the first vehicle, exterior sensor data representing a location of at least one second vehicle traveling along the roadway and in close proximity to the first vehicle;
determine a first beam of the plurality of beams allocated for the first vehicle based on the location data and the exterior sensor data from the first vehicle;
receive a precoding matrix indicator (PMI) and a channel quality indicator (CQI) from at least one of the cellular communication capable devices in the first vehicle;
determine a second beam of the plurality of beams based on the PMI and the CQI;
in response to the first beam being different than the second beam, select the first beam for the first vehicle;
receive a subsequent CQI from at least one of the cellular communication capable devices based on the selected first beam; and
in response to the subsequent CQI being less than a defined threshold, select the second beam for the first vehicle.
